(19) United States
(12) Patent Application Publication
(10) Pub. No.: US 2008/0091877 A1
(43) Pub. Date: Apr. 17, 2008

(54) DATA PROGRESSION DISK LOCALITY OPTIMIZATION SYSTEM AND METHOD

(76) Inventors: Michael J. Klemm, Minnetonka, MN (US); Lawrence E. Aszmann, Prior Lake, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/753,357

(22) Filed: May 24, 2007

Related U.S. Application Data
(60) Provisional application No. 60/808,058, filed on May 24, 2006.

(51) Int. Cl. G06F 12/00

(52) U.S. Cl. 711/114; 711/E12.001

(57) ABSTRACT

The present disclosure relates to disk drive systems and methods having data progression and disk placement optimizations. Generally, the systems and methods include continuously determining a cost for data on a plurality of disk drives, determining whether there is data to be moved from a first location on the disk drives to a second location on the disk drives, and moving data stored at the first location to the second location. The first location is a data track that is located generally concentrically closer to a center of a first disk drive than the second location is located relative to a center of a second disk drive. In some embodiments, the first and second location are on the same disk drive.

### CROSS-REFERENCE TO RELATED APPLICATION(S)

This application claims priority to U.S. Prov. Pat. Appl. No. 60/808,058, filed May 24, 2006, which is incorporated herein by reference in its entirety.

### FIELD OF THE INVENTION

Various embodiments of the present disclosure relate generally to disk drive systems and methods, and more particularly to disk drive systems and methods having data progression that allow a user to configure disk classes, Redundant Array of Independent Disk (RAID) levels, and disk placement optimizations to maximize performance and protection of the systems.

### BACKGROUND OF THE INVENTION

Virtualized volumes use blocks from multiple disks to create volumes and implement RAID protection across multiple disks. The use of multiple disks allows the virtual volume to be larger than any one disk, and using RAID provides protection against disk failures. Virtualization also allows multiple volumes to share space on a set of disks by using a portion of the disk.

Disk drive manufacturers have developed Zone Bit Recording (ZBR) and other techniques to better use the surface area of the disk. The same angular rotation on the outer tracks covers a longer space than the inner tracks. Disks contain different zones where the number of sectors increases as the disk moves to the outer tracks, as shown in FIG. 1, which illustrates ZBR sector density 100 of a disk.

Compared to the innermost track, the outermost track of a disk may contain more sectors. The outermost tracks also transfer data at a higher rate. Specifically, a disk maintains a constant rotational velocity, regardless of the track, allowing the disk to transfer more data in a given time period when the input/output (I/O) is for the outermost tracks.

A disk breaks the time spent servicing an I/O into three different components: seek, rotational, and data transfer. Seek latency, rotational latency, and data transfer times vary depending on the I/O load for a disk and the previous location of the heads. Relatively, seek and rotational latency times are much greater than the data transfer time. Seek latency time, as used herein, may include the length of time required to move the head from the current track to the track for the next I/O. Rotational latency time, as used herein, may include the length of time waiting for the desired blocks of data to rotate underneath the head. The rotational latency time is generally less than the seek latency time. Data transfer time, as used herein, may include the length of time it takes to transfer the data to and from the platter. This portion represents the shortest amount of time for the three components of a disk I/O.

Storage Area Network (SAN) and previous disk I/O subsystems have used a reduced address range to maximize input/output per second (IOPS) for performance testing. Using a reduced address range reduces the seek time of a disk by physically limiting the distance the disk heads must travel. FIG. 2 illustrates an example graph 200 of the change in IOPS when the logical block address (LBA) range accessed increases.

SAN implementations have previously allowed the prioritization of disk space by track at the volume level, as illustrated in the schematic of a disk track allocation 300 in FIG. 3. This allows the volume to be designated to a portion of the disk at the time of creation. Volumes with higher performance needs are placed on the outermost tracks to maximize the performance of the system. Volumes with lower performance needs are placed on the inner tracks of the disks. In such implementations, the entire volume, regardless of use, is placed on a specific set of tracks. This implementation does not address the portions of a volume on the outermost tracks that are not used frequently, or portions of a volume on the innermost tracks that are used frequently. The I/O pattern of a typical volume is not uniform across the entire LBA range. Typically, I/O is concentrated on a limited number of addresses within the volume. This creates problems as infrequently accessed data for a high priority volume uses the valuable outer tracks, and heavily used data of a low priority volume uses the inner tracks.

FIG. 4 depicts that the volume I/O may vary depending on the LBA range. For example, some LBA ranges service relatively heavy I/O 410, while others service relatively light I/O 440. Volume 1 420 services more I/O for LBA ranges 1 and 2 than for LBA ranges 0, 3, and 4. Volume 2 430 services more I/O for LBA range 0 and less I/O for LBA ranges 1, 2, and 3. Placing the entire contents of Volume 1 420 on the better performing outer tracks does not utilize the full potential of the outer tracks for LBA ranges 0, 3, and 4. The implementations do not look at the I/O pattern within the volume to optimize to the page level.

Therefore, there is a need in the art for disk drive systems and methods having data progression that allow a user to configure disk classes, Redundant Array of Independent Disk (RAID) levels, and disk placement optimizations to maximize performance and protection of the systems. There is a further need in the art for disk placement optimizations, wherein frequently accessed data portions of a volume are placed on the outermost tracks of a disk and infrequently accessed data portions of a volume are placed on the inner tracks of a disk.

### BRIEF SUMMARY OF THE INVENTION

The present invention, in one embodiment, is a method of disk locality optimization in a disk drive system. The method includes continuously determining a cost for data on a plurality of disk drives, determining whether there is data to be moved from a first location on the disk drives to a second location on the disk drives, and moving data stored at the first location to the second location. The first location is a data track that is located generally concentrically closer to a center of a first disk drive than the second location is located relative to a center of a second disk drive. In some embodiments, the first and second location are on the same disk drive.

The present invention, in another embodiment, is a disk drive system having a RAID subsystem and a disk manager. The disk manager is configured to continuously determine a cost for data on a plurality of disk drives of the disk drive system, continuously determine whether there is data to be moved from a first location on the disk drives to a second location on the disk drives, and move data stored at the first location to the second location. As mentioned before, the first location is a data track that is located generally concentrically closer to a center of a first disk drive than the second location is located relative to either the center of the first disk drive or a center of a second disk drive.

The present invention, in yet another embodiment, is a disk drive system capable of disk locality optimization. The disk drive system includes means for storing data and means for continuously checking a plurality of data on the means for storing data to determine whether there is data to be moved from a first location to a second location. The system further includes means for moving data stored in the first location to the second location. The first location is a data track located in a higher performing mechanical position of the means for storing data than the second location.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the embodiments of the present invention, it is believed that the invention will be better understood from the following description taken in conjunction with the accompanying Figures, in which:

FIG. 1 illustrates conventional zone bit recording disk sector density.

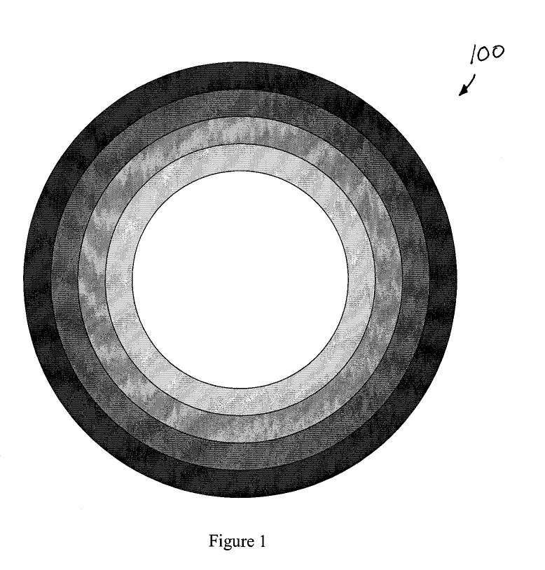

FIG. 2 illustrates a conventional I/O rate as the LBA range accessed increases.

FIG. 3 illustrates a conventional prioritization of disk space by track at the volume level.

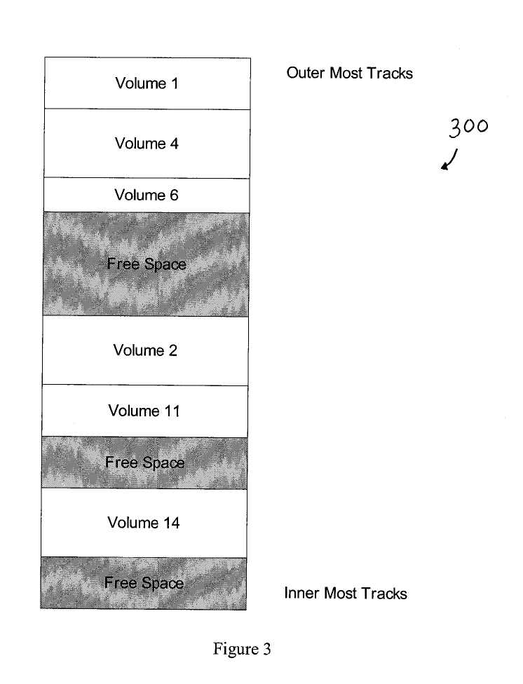

FIG. 4 illustrates differing volume I/O depending on the LBA range.

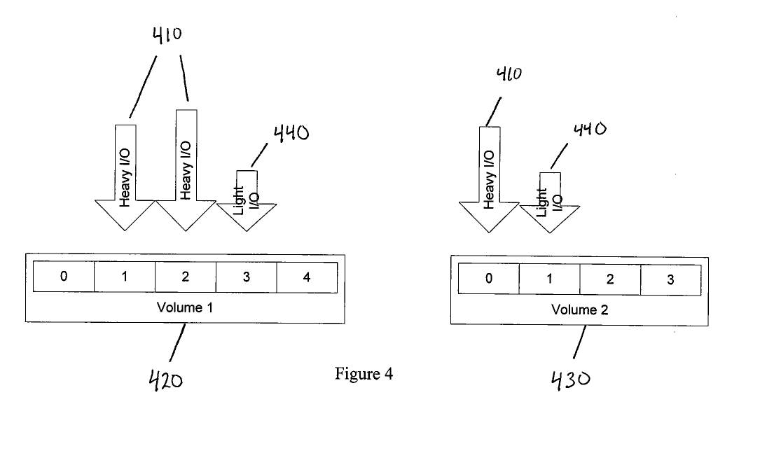

FIG. 5 illustrates an embodiment of accessible data pages for a data progression operation in accordance with the principles of the present invention.

FIG. 6 is a schematic view of an embodiment of a mixed RAID waterfall data progression in accordance with the principles of the present invention.

FIG. 7 is a flow chart of an embodiment of a data progression process in accordance with the principles of the present invention.

FIG. 8 illustrates an embodiment of a database example in accordance with the principles of the present invention.

FIG. 9 illustrates an embodiment of a MRI image example in accordance with the principles of the present invention.

FIG. 10 illustrates an embodiment of data progression in a high level disk drive system in accordance with the principles of the present invention.

FIG. 11 illustrates an embodiment of the placement of volume data on various RAID devices on different tracks of sets of disks in accordance with the principles of the present invention.

### DETAILED DESCRIPTION

Various embodiments of the present disclosure relate generally to disk drive systems and methods, and more particularly to disk drive systems and methods having data progression that allow a user to configure disk classes, Redundant Array of Independent Disk (RAID) levels, and disk placement optimizations to maximize performance and protection of the systems. Data Progression Disk Locality Optimization (DP DLO) maximizes the IOPS of virtualized disk drives (volumes) by grouping frequently accessed data on a limited number of high-density disk tracks. DP DLO performs this by differentiating the I/O load for defined portions of the volume and placing the data for each portion of the volume on disk storage appropriate to the I/O load.

Data Progression

In one embodiment of the present invention, Data Progression (DP) may be used to move data gradually to storage space of appropriate cost. The present invention may allow a user to add drives at the time when the drives are actually needed. This may significantly reduce the overall cost of the disk drives.

DP may move non-recently accessed data and historical snapshot data to less expensive storage. For a detailed description of DP and historical snapshot data, see copending, published U.S. patent application Ser. No. 10/918,329, entitled “Virtual Disk Drive System and Method,” the subject matter of which is herein incorporated by reference in its entirety. For non-recently accessed data, DP may gradually reduce the cost of storage for any page that has not been recently accessed. In some embodiments, the data need not be moved to the lowest cost storage immediately. For historical snapshot data (e.g., backup data), DP may move the read-only pages to more efficient storage space, such as RAID 5. In a further embodiment, DP may move historical snapshot data to the least expensive storage if the page is no longer accessible by a volume. Other advantages of DP may include maintaining fast I/O access to data currently being accessed and reducing the need to purchase additional fast, expensive disk drives.

In operation, DP may determine the cost of storage using the cost of the physical media and the efficiency of RAID devices that are used for data protection. For example, DP may determine the storage efficiency of RAID devices and move the data accordingly. As an additional example, DP may convert one level of RAID device to another, e.g., RAID 10 to RAID 5, to more efficiently use the physical disk space.

Accessible data, as used herein with respect to DP, may include data that can be read or written by a server at the current time. DP may use the accessibility to determine the class of storage a page should use. In one embodiment, a page may be read-only if it belongs to a historical point-in-time copy (PITC). For a detailed description of PITC, see copending, published U.S. patent application Ser. No. 10/918,329, the subject matter of which was previously herein incorporated by reference in its entirety. If the server has not updated the page in the most recent PITC, the page may still be accessible.

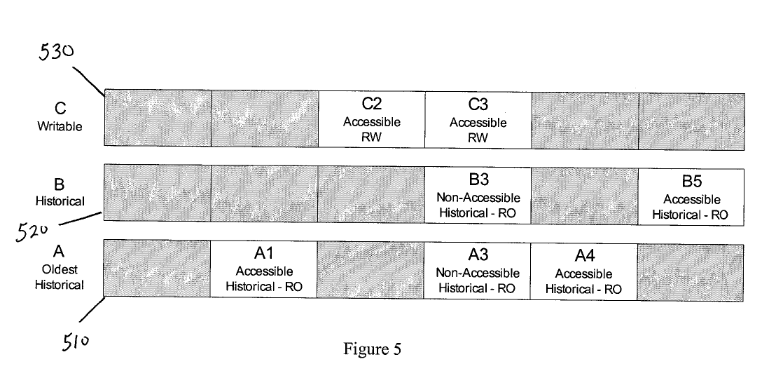

FIG. 5 illustrates one embodiment of accessible data pages 510, 520, 530 in a DP operation. In one embodiment, the accessible data pages may be broken down into one or more of the following categories:
Accessible Recently Accessed—the active pages the volume is using the most.
Accessible Non-recently Accessed—read-write pages that have not been recently used.
Historical Accessible—read-only pages that may be read by a volume. This category may typically apply to snapshot volumes. For a detailed description of snapshot volumes, see copending, published U.S. patent application Ser. No. 10/918,329, the subject matter of which was previously herein incorporated by reference in its entirety.
Historical Non-Accessible—read-only data pages that are not being currently accessed by a volume. This category may also typically apply to snapshot volumes. Snapshot volumes may maintain these pages for recovery purposes, and the pages may be placed on the lowest cost storage possible.

In FIG. 5, three PITC with various owned pages for a snapshot volume are illustrated. A dynamic capacity volume may be represented solely by PITC C 530. All of the pages may be accessible and readable-writable. The pages may have different access times.

DP may further include the ability to automatically classify disk drives relative to the drives within a system. The system may examine a disk to determine its performance relative to the other disks in the system. The faster disks may be classified in a higher value classification, and the slower disks may be classified in a lower value classification. As disks are added to the system, the system may further automatically rebalance the value classifications of the disks. This approach can handle at least systems that never change and systems that change frequently as new disks are added. In some embodiments, the automatic classification may place multiple drive types within the same value classification. In further embodiments, drives that are determined to be close enough in value may be considered to have the same value.

Some types of disks are shown in the following table:

TABLE 1
Disk Types

| Type | Speed | Cost | Issues |
|---|---|---|---|
| 2.5 Inch FC | Great | High | Very Expensive |
| FC 15K RPM | Good | Medium | Expensive |
| FC 10K RPM | Good | Good | Reasonable |
| | | | Price |
| SATA | Fair | Low | Cheap/Less |
| | | | Reliable |

In one embodiment, for example, a system may contain the following drives:

High—10K Fibre Channel (FC) drive

Low—SATA drive

With the addition of a 15K FC drive, DP may automatically reclassify the disks and demote the 10K FC drive. This may result in the following classifications:

High—15K FC drive

Medium—10K FC drive

Low—SATA drive

In another embodiment, for example, a system may have the following drive types:

High—25K FC drive

Low—15K FC drive

Accordingly, the 15K FC drive may be classified as the lower value classification, whereas the 25K FC drive may be classified as the higher value classification.

If a SATA drive is added to the system, DP may automatically reclassify the disks. This may result in the following classification:

High—25K FC drive

Medium—15K FC drive

Low—SATA drive

In one embodiment, DP may determine the value of RAID space from the disk type, RAID level, and disk tracks used. In other embodiments, DP may determine the value of RAID space using other characteristics of the disks or RAID space. In a further embodiment, DP may use Equation 1 to determine the value of RAID space.

$$Disk Type V alue * \frac{RAID Disk Blocks \text{/} Stripe}{RAID User Blocks \text{/} Stripe} * Disk Tracks Value = RAID Space Value \qquad Equation 1$$

Inputs to Equation 1 may include Disk Type Value, RAID Disks Blocks/Stripe, RAID User Blocks/Stripe, and Disk Tracks value. However, Equation 1 is not limiting, and in other embodiments, other inputs may be used in Equation 1 or other equations may be used to determine the value of RAID space.

Disk Type Value, as used in one embodiment, may be an arbitrary value based on the relative performance characteristics of the disk compared to other disks available for the system. Classes of disks may include 15K FC, 10K FC, SATA, SAS, and FATA, etc. In further embodiments, other classes of disks may be included. Similarly, the variety of disk classes may increase as time moves forward and is not limited to the previous list. In one embodiment, testing may be used to measure the I/O potential of the disk in a controlled environment. The disk with the best I/O potential may be assigned the highest value.

RAID levels may include RAID 10, RAID 5-5, RAID 5-9, and RAID 0, etc. RAID Disk Blocks/Stripe, as used in one embodiment, may include the number of blocks in a RAID. RAID User Blocks/Stripe, as used in one embodiment, may include the number of protected blocks a RAID stripe provides to the user of the RAID. In the case of RAID 0, the blocks may not be protected. The ratio of the RAID Disk Blocks/Stripe and RAID User Blocks/Stripe may be used to determine the efficiency of the RAID. The inverse of the efficiency may be used to determine the value of the RAID.

Disk Tracks Value, as used in one embodiment, may include an arbitrary value to allow the comparison of the outer and inner tracks of the disks. Disk Locality Optimization (DLO), discussed in further detail below, may place a higher value on the higher performing outer tracks of the disk than the inner tracks.

The output of Equation 1 may generate a relative RAID Space Value against other configured RAID space within the system. A higher value may typically be interpreted as better performance of the RAID space.

In alternative embodiments, other equations or methods may be used to determine the value of RAID space. DP may then use the value to order an arbitrary number of RAID spaces within the system. The highest value RAID space may typically provide the best performance for the data stored. The highest value RAID space may typically use the fastest disks, most efficient RAID level, and the fastest tracks of the disk.

Table 2 illustrates various storage devices, for one embodiment, in an order of increasing efficiency or decreasing monetary expense. The list of storage devices may also follow a general order of slower write I/O access. DP may compute efficiency of the logical protected space divided by the total physical space of a RAID device.

TABLE 2
RAID Levels

| | | | 1 Block | |
|---|---|---|---|---|
| | Sub | Storage | Write | |
| Type | Type | Efficiency | I/O Count | Usage |
| RAID | | 50% | 2 | Primary Read-Write |
| 10 | | | | Accessible Storage with |
| | | | | relatively good write |
| | | | | performance. |
| RAID | 3 - | 66.6% | 4 (2 | Minimum efficiency gain |
| 5 | Drive | | Read - 2 | over RAID 10 while |
| | | | Write) | incurring the RAID 5 write |
| | | | | penalty. |
| RAID | 5 - | 80% | 4 (2 | Great candidate for Read- |
| 5 | Drive | | Read - 2 | only historical information. |
| | | | Write) | Good candidate for non- |
| | | | | recently accessed writable |
| | | | | pages. |
| RAID | 9 - | 88.8% | 4 (2 | Great candidate for read-only |
| 5 | Drive | | Read - 2 | historical information. |
| | | | Write) | |
| RAID | 17 - | 94.1% | 4 (2 | Reduced gain for efficiency |
| 5 | Drive | | Read - 2 | while doubling the fault |
| | | | Write) | domain of a RAID device. |

RAID 5 efficiency may increase as the number of disk drives in the stripe increases. As the number of disks in a stripe increases, the fault domain may increase. Increasing the number of drives in a stripe may also increase the minimum number of disks necessary to create the RAID devices. In one embodiment, DP may use RAID 5 stripe sizes that are integer multiples of the snapshot page size. This may allow DP to perform full-stripe writes when moving pages to RAID 5, making the move more efficient. All RAID 5 configurations may have the same write I/O characteristic for DP purposes. For example, RAID 5 on a 2.5 inch FC disk may not effectively use the performance of those disks well. To prevent this combination, DP may support the ability to prevent a RAID level from running on certain disk types. The configuration of DP can prevent the system from using any specified RAID level, including RAID 10, RAID 5, etc. and is not limited to preventing use only in relation to 2.5 inch FC disks.

In some embodiments, DP may also include waterfall progression. In one embodiment, waterfall progression may move data to less expensive resources only when more expensive resources becomes totally used. In other embodiments, waterfall progression may move data immediately, after a predetermined period of time, etc. Waterfall progression may effectively maximize the use of the most expensive system resources. It may also minimize the cost of the system. Adding cheap disks to the lowest pool can create a larger pool at the bottom.

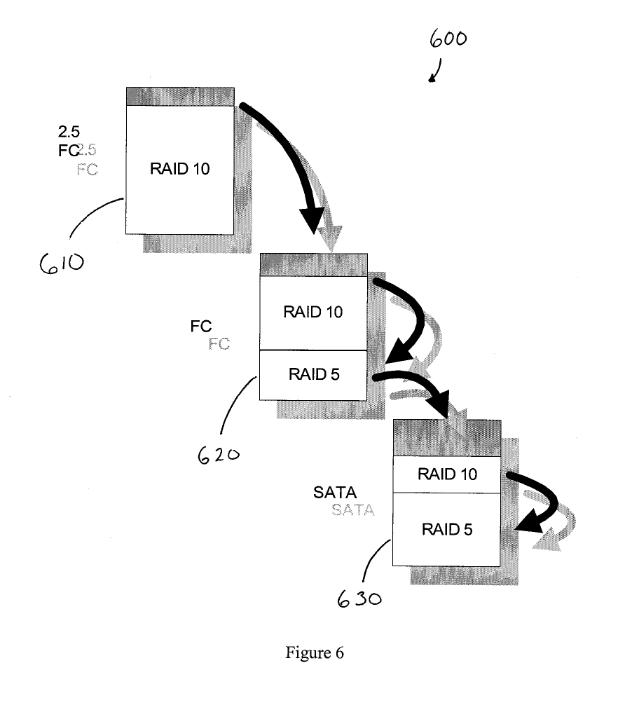

In one embodiment, for example, waterfall progression may use RAID 10 space followed by a next level of RAID space, such as RAID 5 space. In a further embodiment, waterfall progression may force the waterfall from a RAID level, such as RAID 10, on one class of disks, such as 15K FC, directly to the same RAID level on another class of disks, such as 10K FC. Alternatively, DP may include mixed RAID waterfall progression 600, as shown in FIG. 6 for example. In FIG. 6, a top level 610 of the waterfall may include RAID 10 space on 2.5 inch FC disks, a next level 620 of the waterfall may include RAID 10 and RAID 5 space on 15K FC disks, and a bottom level 630 of the waterfall may include RAID 10 and RAID 5 space on SATA disks. FIG. 6 is not limiting, and an embodiment of a mixed waterfall progression may include any number of levels and any variety of RAID space on any variety of disks. This alternative DP method may solve the problem of maximizing disk space and performance and may allow storage to transform into a more efficient form in the same disk class. This alternative method may also support a requirement that more than one RAID level, such as RAID 10 and RAID 5, share the total resource of a disk class. This may include configuring a fixed percentage of disk space a RAID level may use for a class of disks. Accordingly, the alternative DP method may maximize the use of expensive storage, while allowing room for another RAID level to coexist.

In a further embodiment, a mixed RAID waterfall may only move pages to less expensive storage when the storage is limited. A threshold value, such as a percentage of the total disk space, may limit the amount of storage of a certain RAID level. This can maximize the use of the most expensive storage in the system. When a storage approaches its limit, DP may automatically move the pages to lower cost storage. Additionally, DP may provide a buffer for write spikes.

It is appreciated that the above waterfall methods may move pages immediately to the lowest cost storage since for some cases, there may be a need in moving historical and non-accessible pages onto less expensive storage in a timely fashion. Historical pages may also be initially moved to less expensive storage.

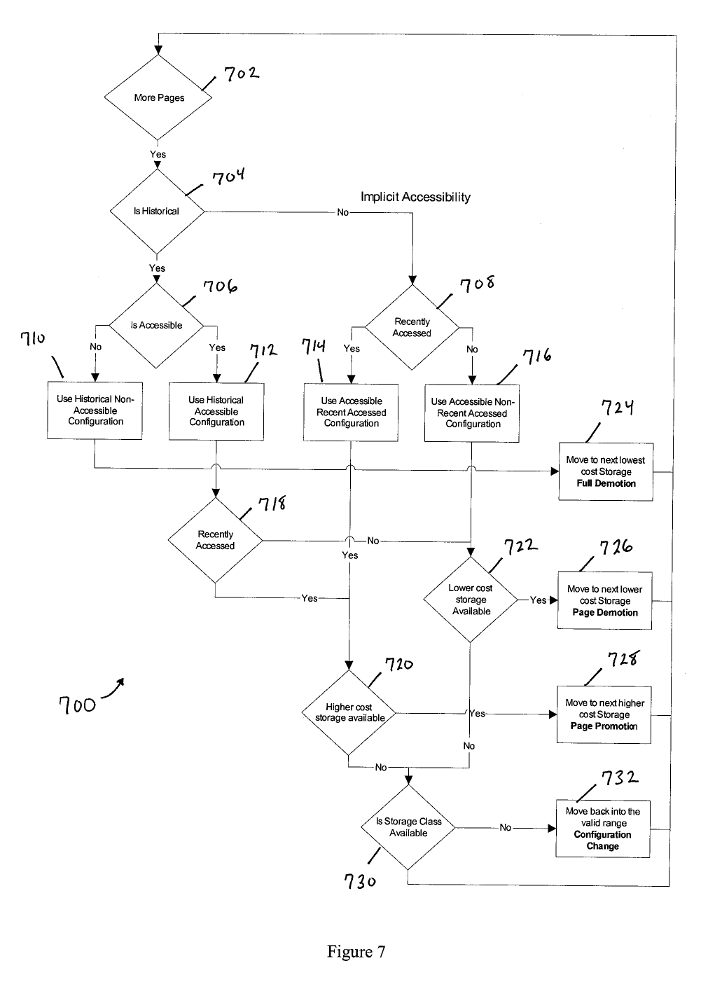

FIG. 7 illustrates a flow chart of one embodiment of a DP process 700. DP may continuously check each page in the system for its access pattern and storage cost to determine whether there are data pages to move, as shown in steps 702, 704, 706, 708, 710, 712, 714, 716, and 718. For example, if more pages need to be checked (step 702), then the DP process 700 may determine whether the page contains historical data (step 704) and is accessible (step 706) and then whether the data has been recently accessed (steps 708 and 718). Following the above determinations, the DP process 700 may determine whether storage space is available at a higher or lower RAID cost (steps 720 and 722) and may demote or promote the data to the available storage space (steps 724, 726, and 728). If no storage space is available and no disk storage class is available for a particular RAID level (steps 730 and 732), the DP process 700 may reconfigure the disk system, for example, by creating RAID storage space on a borrowed disk storage class, as will be described in further detail below. DP may also determine if the storage has reached its maximum allocation.

In other words, in further embodiments, a DP process may determine if the page is accessible by any volume. The process may check PITC for each volume attached to a history to determine if the page is referenced. If the page is actively being used, the page may be eligible for promotion or a slow demotion. If the page is not accessible by any volume, it may be moved to the lowest cost storage available.

In a further embodiment, DP may include recent access detection that may eliminate promoting a page due to a burst of activity. DP may separate read and write access tracking. This may allow DP to keep data on RAID 5 devices, for example, that are accessible. Similarly, operations like a virus scan or reporting may only read the data. In further embodiments, DP may change the qualifications of recent access when storage is running low. This may allow DP to more aggressively demote pages. It may also help fill the system from the bottom up when storage is running low.

In yet another embodiment, DP may aggressively move data pages as system resources become low. In some embodiments, more disks or a change in configuration may be necessary to correct a system with low resources. However, in some embodiments, DP may lengthen the amount of time that the system may operate in a tight situation. That is, DP may attempt to keep the system operational as long as possible.

In one embodiment where system resources may be low, such as where RAID 10 space, for example, and total available disk space are running low, DP may cannibalize RAID 10 disk space to move to more efficient RAID 5 disk space. This may increase the overall capacity of the system at the price of write performance. In some embodiments, more disks may still be necessary. Similarly, if a particular storage class is completely used, DP may allow for borrowing on non-acceptable pages to keep the system running. For example, if a volume is configured to use RAID 10 FC for its accessible information, it may allocate pages from RAID 5 FC or RAID 10 SATA until more RAID10 FC space is available.

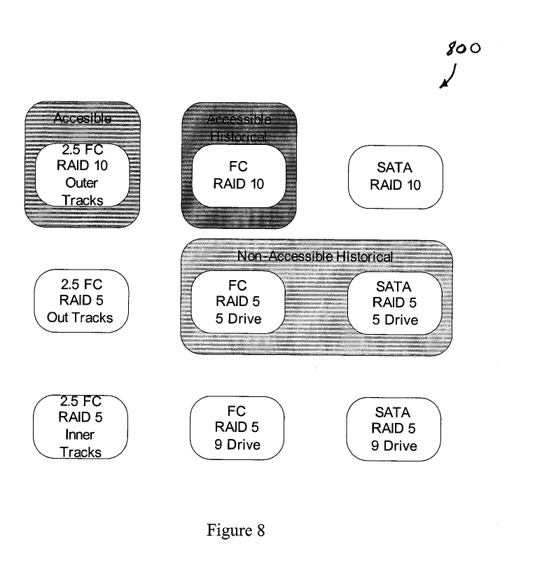

FIG. 8 illustrates one embodiment of a high performance database 800 where all accessible data only resides on 2.5 FC drives, even if it is not recently accessed. As can be seen in FIG. 8, for example, accessible data may be stored on the outer tracks of RAID 10 2.5 inch FC disks. Similarly, non-accessible historical data may be moved to RAID 5 FC.

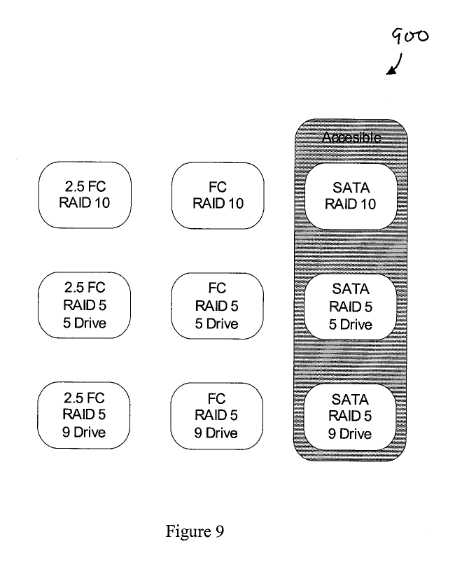

FIG. 9 illustrates one embodiment of a MRI image volume 900 where accessible storage is SATA, RAID 10, and RAID 5. If the image is not recently accessed, the image may be moved to RAID 5. New writes may then initially go to RAID 10.

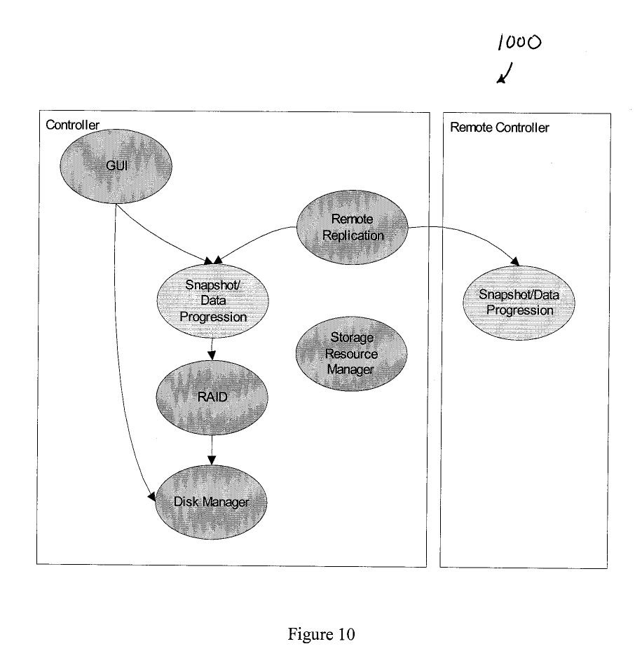

FIG. 10 illustrates one embodiment of DP in a high level disk drive system 1000. DP need not change the external behavior of a volume or the operation of the data path. DP may require modification to a page pool. A page pool may contain a list of free space and device information. The page pool may support multiple free lists, enhanced page allocation schemes, the classification of free lists, etc. The page pool may further maintain a separate free list for each class of storage. The allocation schemes may allow a page to be allocated from one of many pools while setting minimum or maximum allowed classes. The classification of free lists may come from the device configuration. Each free list may provide its own counters for statistics gathering and display. Each free list may also provide the RAID device efficiency information for the gathering of storage efficiency statistics.

In one embodiment of DP, the PITC may identify candidates for movement and may block I/O to accessible pages when they move. DP may continually examine the PITC for candidates. The accessibility of pages may continually change due to server I/O, new snapshot page updates, view volume creation/deletion, etc. DP may also continually check volume configuration changes and summarize the current list of page classes and counts. This may allow DP to evaluate the summary and determine if there are pages to be moved. Each PITC may present a counter for the number of pages used for each class of storage. DP may use this information to identify a PITC that makes a good candidate to move pages when a threshold is reached.

A RAID system may allocate a device from a set of disks based on the cost of the disks. A RAID system may also provide an API to retrieve the efficiency of a device or potential device. Additionally, a RAID system may return information on the number of I/O required for a write operation. DP may use a RAID NULL to use third-party RAID controllers. A RAID NULL may consume an entire disk and may merely act as a pass through layer.

A disk manager may also be used to automatically determine and store the disk classification. Automatically determining the disk classification may require changes to a SCSI Initiator.

Disk Locality Optimization

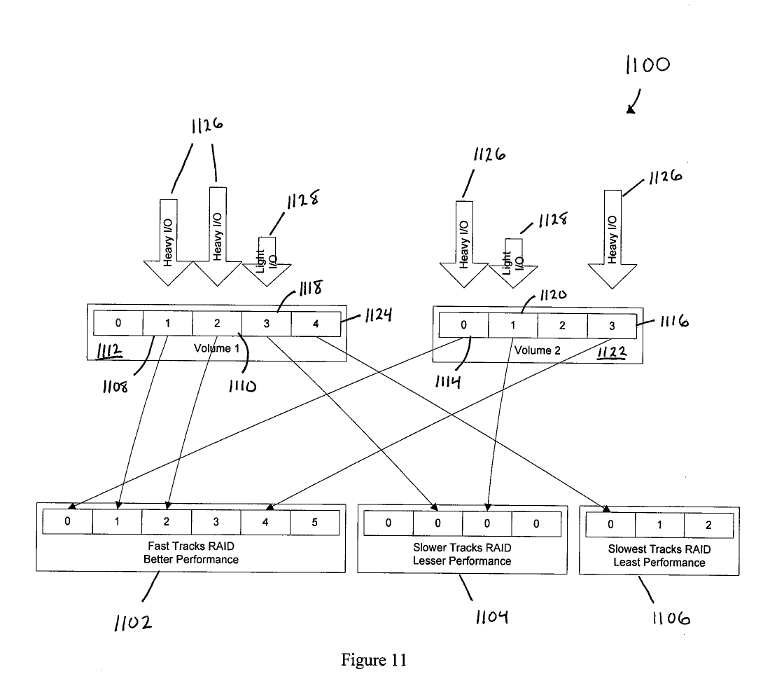

DLO may group frequently accessed data on the outer tracks of a disk to improve the performance of the system. The frequently accessed data may be the data from any volume within the system. FIG. 11 illustrates an example placement 1100 of volume data on various RAID devices on different tracks 1102, 1104, 1106 of sets of disks. The various LBA ranges for the volume data service varying amounts of I/O (e.g., heavy I/O 1126 and light I/O 1128). For example, volume data 1 1108 and volume data 2 1110 of Volume 1 1112 and volume data 0 1114 and volume data 3 1116 of Volume 2 1122, each having heavy I/O 1126, may be placed on the better performing outer tracks 1102. Similarly, volume data 3 1118 of Volume 1 1112 and volume data 1 1120 of Volume 2 1122, each having light I/O 1128, may be placed on relatively lesser performing tracks 1104. And, volume data 4 1124 of Volume 1 1112 may be placed on the relatively least performing tracks 1106. FIG. 11 is for illustration and is not limiting. Other placements of the data on the disk tracks are envisioned by the present disclosure. DLO may leverage ‘short-stroking’ performance optimizations and high data transfer rates to increase the I/O rate to the individual disks.

Accordingly, DLO may allow the system to maintain a high performance level as larger disks are added and/or more inactivate data is stored to the system. Approximately 80% to 85% of data contained within many current embodiments of a SAN is inactive. Additionally, features like Data Instant Replay (DIR) increase the amount of inactive data since more backup information is stored within the SAN itself. For a detailed description of DIR, see copending, published U.S. patent application Ser. No. 10/918,329, the subject matter of which was previously herein incorporated by reference in its entirety. The inactive and inaccessible replay, or backup, data may cover a large percentage of data stored on the system without much active I/O. Grouping the frequently used data may allow large and small systems to provide better performance.

In one embodiment, DLO may reduce seek latency time, rotational latency time, and data transfer time. DLO may reduce the seek latency time by requiring less head movement between the most frequently used tracks. DLO may take the disk less time to move to nearby tracks than far away tracks. The outer tracks may also contain more data than the inner tracks. The rotational latency time may generally be less than the seek latency time. In some embodiments, DLO may not directly reduce the rotational latency time of a request. However, it may indirectly reduce the rotational latency time by reducing the seek latency time, thereby allowing the disk to complete multiple requests for a single rotation of the disk. DLO may reduce data transfer time by leveraging the improved I/O transfer rate for the outermost tracks. In some embodiments, this may provide a minimal gain compared to the gain from seek and rotational latency times. However, it still may provide a beneficial outcome for this optimization.

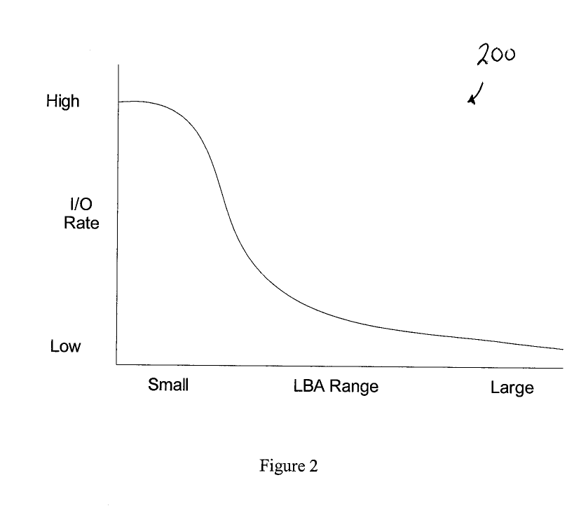

In one embodiment, DLO may first differentiate the better performing portion of a disk, e.g., 1102. As previously discussed, FIG. 2 shows that as the accessed LBA range for a disk increases the total I/O performance for the disk decreases. DLO may identify the better performing portion of a disk and allocate volume RAID space within the boundaries of that space.

In one embodiment, DLO may not assume LBA 0 is on the outermost track. The highest LBA on the disk may be on the outermost tracks. Furthermore, in one embodiment, DLO may be a factor DP uses to prioritize the use of disk space. In other embodiments, DLO may be separate and distinct from DP. In yet further embodiments, the methods used in determining the value of disk space and the progression of data in accordance with DP, as described herein, may be applicable in determining the value of disk space and the progression of data in accordance with DLO.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention.

In various embodiments of the present invention, disk classes, RAID levels, disk locality, and other features provide a substantial number of options. For example, DP DLO may work with various disk drive technologies, including FC, SATA, and FATA. Similarly, DLO may work with various RAID levels including RAID 0, RAID 1, RAID 10, RAID 5, and RAID 6 (Dual Parity), etc. DLO may place any RAID level on the faster or slower tracks of a disk.

We claim:

1. A method of disk locality optimization in a disk drive system, comprising:
determining a cost for each of a plurality of data on a plurality of disk drives of the disk drive system;
determining whether there is data to be moved from a first location on the plurality of disk drives to a second location on the plurality of disk drives; and
moving data stored at the first location to the second location;
wherein the first location is a data track that is located generally concentrically closer to a center of a first disk drive than the second location is located relative to a center of a second disk drive.

2. The method of claim 1, wherein the cost of each of the plurality of data is based on the access pattern of the data.

3. The method of claim 2, wherein determining whether there is data to be moved from a first location on the plurality of disk drives to a second location on the plurality of disk drives comprises determining whether data on the first location has an access pattern suitable for moving to the second location.

4. The method of claim 2, wherein the first and second disk drive are the same and the second location is a data track located on the first disk drive.

5. The method of claim 3, wherein the plurality of data on the plurality of disk drives comprises data from a plurality of RAID devices allocated into volumes.

6. The method of claim 5, wherein each of the plurality of data on the plurality of disk drives comprises a subset of a volume.

7. The method of claim 1, further comprising:
determining whether there is data to be moved from a third location on the plurality of disk drives to a fourth location on the plurality of disk drives; and
moving data stored at the third location to the fourth location;
wherein the third location is a data track that is located generally concentrically further away from a center of a third disk drive than the fourth location is located relative to a center of a fourth disk drive.

8. The method of claim 7, wherein the cost of each of the plurality of data is based on at least one of the access pattern of the data and the type of data.

9. The method of claim 8, wherein data is moved from the third location to the fourth location if the data comprises historical snapshot data.

10. The method of claim 8, wherein the third and fourth disk drives are the same and the fourth location is a data track located on the third disk drive.

11. A disk drive system, comprising:
a RAID subsystem comprising a pool of storage; and
a disk manager having at least one disk storage system controller configured to:
determine a cost for each of a plurality of data on a plurality of disk drives of the disk drive system;
continuously determine whether there is data to be moved from a first location on the plurality of disk drives to a second location on the plurality of disk drives; and
move data stored at the first location to the second location;
wherein the first location is a data track that is located generally concentrically closer to a center of a first disk drive than the second location is located relative to one of the center of the first disk drive and a center of a second disk drive.

12. The system of claim 11, wherein the disk drive system comprises storage space from at least one of a plurality of RAID levels including RAID-0, RAID-1, RAID-5, and RAID-10.

13. The system of claim 12, further comprising RAID levels including RAID-3, RAID-4, RAID-6, and RAID-7.

14. A disk drive system capable of disk locality optimization, comprising:
means for storing data;
means for checking a plurality of data on the means for storing data to determine whether there is data to be moved from a first location to a second location, wherein the first location is a data track located in a higher performing mechanical position of the means for storing data than the second location; and
means for moving data stored in the first location to the second location.

15. The disk drive system of claim 14, wherein the first location is a data track that is located generally concentrically closer to a center of a first disk drive than the second location is located relative to one of the center of the first disk drive and a center of a second disk drive.

16. A method for reducing the cost of storing data, comprising:
assessing an access pattern for data stored on a first disk; and
based on at least the access pattern, moving data to at least one of outer tracks and inner tracks of a second disk.

17. The method of claim 16, wherein the first and second disk drives are the same disks.

18. The method of claim 16, wherein the first and second disk drives are different disks.
